(19) United States
(12) Patent Application Publication
(10) Pub. No.: US 2021/0257663 A1
(43) Pub. Date: Aug. 19, 2021

(54) SECONDARY BATTERY

(71) Applicant: MURATA MANUFACTURING CO., LTD., Kyoto (JP)

(72) Inventors: Yuta HIRANO, Kyoto (JP); Takaaki MATSUI, Kyoto (JP); Kazuki HONDA, Kyoto (JP); Keitaro KITADA, Kyoto (JP); Futoshi SATO, Kyoto (JP); Shinji HATAKE, Kyoto (JP); Taichi KOGURE, Kyoto (JP)

(21) Appl. No.: 17/308,690

(22) Filed: May 5, 2021

Related U.S. Application Data
(63) Continuation of application No. PCT/JP2019/044338, filed on Nov. 12, 2019.

(30) Foreign Application Priority Data
Nov. 30, 2018 (JP) 2018-225941

(51) Int. Cl. H01M 10/0567; H01M 4/133; H01M 4/525; H01M 10/0525; H01M 4/134; H01M 4/505; H01M 4/587

(52) U.S. Cl. CPC H01M 10/0567; H01M 4/133; H01M 4/525; H01M 2004/021; H01M 4/134; H01M 4/505; H01M 4/587; H01M 10/0525

(57) ABSTRACT

A secondary battery includes a positive electrode, a negative electrode, and an electrolytic solution. The positive electrode includes a lithium-nickel composite oxide having a layered rock-salt crystal structure. The negative electrode includes graphite. An open circuit potential, versus a lithium reference electrode, of the negative electrode measured in a full charge state is from 19 mV to 86 mV. A potential variation of the negative electrode is greater than or equal to 1 mV when the secondary battery is discharged from the full charge state by a capacity corresponding to 1% of a maximum discharge capacity. The maximum discharge capacity is obtained when the secondary battery is discharged with a constant current from the full charge state until the closed circuit voltage reaches 2.00 V, following which the secondary battery is discharged with a constant voltage of the closed circuit voltage of 2.00 V for 24 hours.

### CROSS REFERENCE TO RELATED APPLICATIONS

The present application is a continuation of PCT patent application no. PCT/JP2019/044338, filed on Nov. 12, 2019, which claims priority to Japanese patent application no. JP2018-225941 filed on Nov. 30, 2018, the entire contents of which are being incorporated herein by reference.

### BACKGROUND

The present technology relates to a secondary battery that includes: a positive electrode including a lithium-nickel composite oxide; and a negative electrode including graphite.

Various electronic apparatuses such as mobile phones have been widely used. Accordingly, a secondary battery is under development as a power source which is smaller in size and lighter in weight and allows for a higher energy density. The secondary battery includes a positive electrode, a negative electrode, and an electrolytic solution.

Various considerations have been given to a configuration of the secondary battery to improve battery characteristics. Specifically, to achieve a higher energy density (a higher capacity), a charge voltage (a potential of a positive electrode versus a lithium reference electrode) is set to about 4.4 V or higher.

### SUMMARY

The present technology relates to a secondary battery that includes: a positive electrode including a lithium-nickel composite oxide; and a negative electrode including graphite.

Electronic apparatuses, on which a secondary battery is to be mounted, are increasingly gaining higher performance and more functions, causing more frequent use of the electronic apparatuses and expanding a use environment of the electronic apparatuses. Accordingly, there is still room for improvement in terms of battery characteristics of the secondary battery.

The present technology has been made in view of such an issue and it is an object of the technology to provide a secondary battery that makes it possible to achieve a superior battery characteristic.

A secondary battery according to an embodiment of the present technology includes a positive electrode, a negative electrode, and an electrolytic solution. The positive electrode includes a lithium-nickel composite oxide represented by Formula (1) and having a layered rock-salt crystal structure. The negative electrode includes graphite. An open circuit potential, versus a lithium reference electrode, of the negative electrode measured in a full charge state is from 19 mV to 86 mV. The full charge state is a state in which the secondary battery is charged with a constant voltage of a closed circuit voltage of higher than or equal to 4.20 V for 24 hours. A potential variation of the negative electrode represented by Formula (2) is greater than or equal to 1 mV when the secondary battery is discharged from the full charge state by a capacity corresponding to 1% of a maximum discharge capacity. The maximum discharge capacity is a discharge capacity obtained when the secondary battery is discharged with a constant current from the full charge state until the closed circuit voltage reaches 2.00 V, following which the secondary battery is discharged with a constant voltage of the closed circuit voltage of 2.00 V for 24 hours.

LiₓNi_{1-y}M_{y}O_{2-z}X_{z} (1)

where:
M represents at least one of titanium (Ti), vanadium (V), chromium (Cr), cobalt (Co), manganese (Mn), iron (Fe), copper (Cu), sodium (Na), magnesium (Mg), aluminum (Al), silicon (Si), tin (Sn), potassium (K), calcium (Ca), zinc (Zn), gallium (Ga), strontium (Sr), yttrium (Y), zirconium (Zr), niobium (Nb), molybdenum (Mo), barium (Ba), lanthanum (La), tungsten (W), or boron (B);
X is at least one of fluorine (F), chlorine (Cl), bromine (Br), iodine (I), sulfur (S), and combinations thereof; and
x, y, and z satisfy 0.8<x<1.2, 0≤y≤0.5, and 0≤z<0.05.

Potential variation (mV) of negative electrode=second negative electrode potential (mV)−first negative electrode potential (mV) (2)

where:
the first negative electrode potential is the open circuit potential, versus the lithium reference electrode, of the negative electrode measured in the full charge state; and the second negative electrode potential is an open circuit potential, versus the lithium reference electrode, of the negative electrode measured in a state in which the secondary battery is discharged from the full charge state by the capacity corresponding to 1 percent of the maximum discharge capacity.

According to the secondary battery of the present technology, the positive electrode includes the lithium-nickel composite oxide, the negative electrode includes the graphite, the open circuit potential of the negative electrode measured in the full charge state is from 19 mV to 86 mV, the potential variation of the negative electrode is greater than or equal to 1 mV when the secondary battery is discharged from the full charge state by the capacity corresponding to 1% of the maximum discharge capacity. Accordingly, it is possible to achieve a superior battery characteristic.

It should be understood that effects of the technology are not necessarily limited to those described above and may include any of a series of effects described below in relation to the technology.

### BRIEF DESCRIPTION OF THE FIGURES

FIG. 1 is a perspective view of a configuration of a secondary battery according to an embodiment of the present technology.

FIG. 2 is a schematic plan view of a wound electrode body illustrated in FIG. 1.

FIG. 3 is an enlarged sectional view of the wound electrode body illustrated in FIG. 1.

FIG. 4 is a capacity potential curve (charge voltage Ec=4.10 V) of a secondary battery according to a comparative example.

FIG. 5 is another capacity potential curve (charge voltage Ec=4.20 V) of the secondary battery according to the comparative example.

FIG. 6 is a capacity potential curve (charge voltage Ec=4.10 V) of a secondary battery according to one embodiment of the technology.

FIG. 7 is another capacity potential curve (charge voltage Ec=4.20 V) of the secondary battery according to the embodiment of the technology.

FIG. 8 is a sectional view of a configuration of a secondary battery according to an embodiment of the present technology.

FIG. 9 is a sectional view of a configuration of a secondary battery according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

A description is given first of a secondary battery according to an embodiment of the technology.

The secondary battery described below is a lithium-ion secondary battery that obtains a battery capacity on the basis of a lithium insertion phenomenon and a lithium extraction phenomenon, as will be described later. The secondary battery includes a positive electrode 13 and a negative electrode 14 (see FIG. 3).

To prevent precipitation of lithium metal on a surface of the negative electrode 14 during charging, an electrochemical capacity per unit area of the negative electrode 14 is greater than an electrochemical capacity per unit area of the positive electrode 13 in the secondary battery.

It should be understood that, however, mass of a positive electrode active material included in the positive electrode 13 is sufficiently greater than mass of a negative electrode active material included in the negative electrode 14 to allow two configuration conditions (a negative electrode potential Ef and a negative electrode potential variation Ev), which will be described later, to be satisfied.

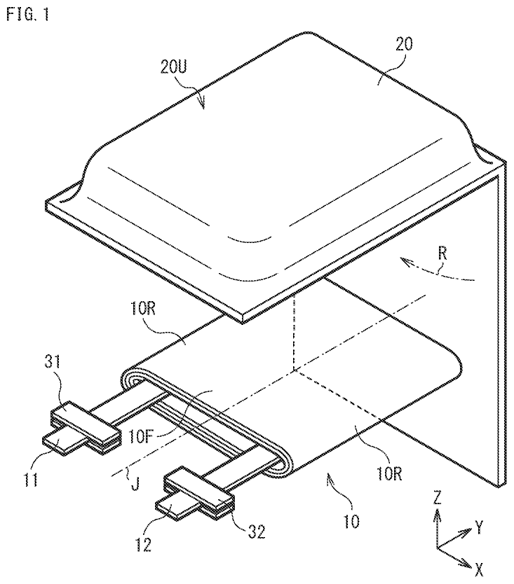

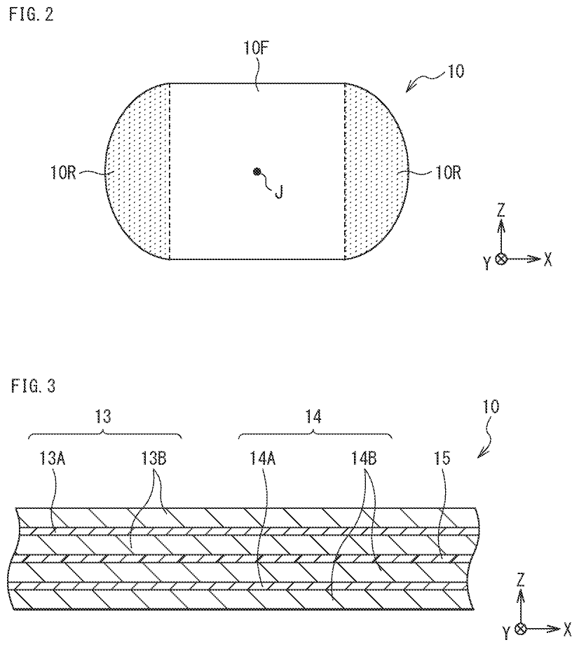

FIG. 1 is a perspective view of a configuration of the secondary battery. FIG. 2 is a schematic plan view of a configuration of a wound electrode body 10 illustrated in FIG. 1. FIG. 3 is an enlarged sectional view of the configuration of the wound electrode body 10. It should be understood that FIG. 1 illustrates a state in which the wound electrode body 10 and an outer package member 20 are separated away from each other, and FIG. 3 illustrates only a portion of the wound electrode body 10.

Referring to FIG. 1, the secondary battery includes, for example, the outer package member 20 having a film shape, and the wound electrode body 10 contained in the outer package member 20. The outer package member 20 has flexibility or softness. The wound electrode body 10 serves as a battery device. A positive electrode lead 11 and a negative electrode lead 12 are coupled to the wound electrode body 10. In other words, the secondary battery described here is a so-called laminated secondary battery.

Referring to FIG. 1, the outer package member 20 is, for example, a single film that is foldable in a direction of an arrow R. The outer package member 20 has a depression 20U, for example. The depression 20U is adapted to contain the wound electrode body 10. Thus, the outer package member 20 contains the wound electrode body 10, thereby containing, for example, the positive electrode 13, the negative electrode 14, and an electrolytic solution to be described later.

The outer package member 20 may be, for example: a film (a polymer film) including a polymer compound; a thin metal plate (a metal foil); or a stacked body (a laminated film) in which the polymer film and the metal foil are stacked on each other. The polymer film may have a single layer or multiple layers. In a similar manner, the metal foil may have a single layer or multiple layers. The laminated film may have, for example, polymer films and metal foils that are alternately stacked. The number of stacked layers of the polymer films and the number of stacked layers of the metal foils may each be set to any value.

In particular, the outer package member 20 is preferably a laminated film. A reason for this is that a sufficient sealing property is obtainable, and sufficient durability is also obtainable. Specifically, the outer package member 20 is a laminated film including, for example, a fusion-bonding layer, a metal layer, and a surface protective layer that are stacked in this order from an inner side to an outer side. In a process of manufacturing the secondary battery, for example, the outer package member 20 is folded in such a manner that portions of the fusion-bonding layer oppose each other with the wound electrode body 10 interposed therebetween. Thereafter, outer edges of the fusion-bonding layer are fusion-bonded to each other, thereby sealing the outer package member 20. The fusion-bonding layer is, for example, a polymer film including polypropylene. The metal layer is, for example, a metal foil including aluminum. The surface protective layer is, for example, a polymer film including nylon.

The outer package member 20 may include, for example, two laminated films that are adhered to each other by means of a material such as an adhesive.

A sealing film 31, for example, is disposed between the outer package member 20 and the positive electrode lead 11. The sealing film 31 is adapted to prevent entry of outside air into the outer package member 20. The sealing film 31 includes, for example, a polyolefin resin such as polypropylene.

A sealing film 32, for example, is disposed between the outer package member 20 and the negative electrode lead 12. The sealing film 32 has a role similar to that of the sealing film 31 described above. A material included in the sealing film 32 is similar to the material included in the sealing film 31.

As illustrated in FIGS. 1 to 3, the wound electrode body 10 includes the positive electrode 13, the negative electrode 14, and a separator 15, for example. In the wound electrode body 10, the positive electrode 13 and the negative electrode 14 are stacked with the separator 15 interposed therebetween, and the positive electrode 13, the negative electrode 14, and the separator 15 are wound, for example. The wound electrode body 10 is impregnated with an electrolytic solution, for example. The electrolytic solution is a liquid electrolyte. The positive electrode 13, the negative electrode 14, and the separator 15 are each impregnated with the electrolytic solution, for example. A surface of the wound electrode body 10 is protected by means of, for example, an unillustrated protective tape.

In a process of manufacturing the secondary battery, which will be described later, a jig having an elongated shape is used to wind the positive electrode 13, the negative electrode 14, and the separator 15 about a winding axis J, for example. The winding axis J is an axis extending in a Y-axis direction. Accordingly, the wound electrode body 10 is formed into an elongated shape resulting from the shape of the jig, as illustrated in FIG. 1, for example. Thus, as illustrated in FIG. 2, for example, the wound electrode body 10 includes a flat part (a flat part 10F) located in the middle and a pair of curved parts (curved parts 10R) located on both sides of the flat part 10F. That is, the pair of curved parts 10R opposes each other with the flat part 10F interposed therebetween. FIG. 2 includes a dashed line that indicates a border between the flat part 10F and each of the curved parts 10R and shading in the curved parts 10R for easier distinction between the flat part 10F and the curved parts 10R.

As illustrated in FIG. 3, the positive electrode 13 includes, for example, a positive electrode current collector 13A, and a positive electrode active material layer 13B provided on the positive electrode current collector 13A. The positive electrode active material layer 13B may be provided, for example, only on one side of the positive electrode current collector 13A, or on each of both sides of the positive electrode current collector 13A. FIG. 3 illustrates a case where the positive electrode active material layer 13B is provided on each of the both sides of the positive electrode current collector 13A, for example.

The positive electrode current collector 13A includes, for example, an electrically conductive material such as aluminum. The positive electrode active material layer 13B includes, as a positive electrode active material or positive electrode active materials, one or more of positive electrode materials into which lithium ions are insertable and from which lithium ions are extractable. The positive electrode active material layer 13B may further include another material, examples of which include a positive electrode binder and a positive electrode conductor.

The positive electrode material includes a lithium compound. The term “lithium compound” is a generic term for a compound that includes lithium as a constituent element. A reason for this is that a high energy density is achievable. The lithium compound includes a lithium-nickel composite oxide having a layered rock-salt crystal structure. Hereinafter, the lithium-nickel composite oxide having the layered rock-salt crystal structure is referred to as a “layered rock-salt lithium-nickel composite oxide”. A reason for this is that a high energy density is stably achievable.

The term “layered rock-salt lithium-nickel composite oxide” is a generic term for a composite oxide that includes lithium and nickel as constituent elements. Accordingly, the layered rock-salt lithium-nickel composite oxide may further include one or more of other elements (elements other than lithium and nickel). The other elements are not limited to particular kinds; however, the other elements may be those belong to groups 2 to 15 in the long periodic table of elements, for example.

Specifically, the layered rock-salt lithium-nickel composite oxide includes one or more of compounds represented by Formula (1) below. A reason for this is that a sufficient energy density is stably achievable. It should be understood that a composition of lithium differs depending on a charging state and a discharging state. A value of x included in Formula (1) represents a value of a state in which the positive electrode 13 is taken out from the secondary battery, following which the positive electrode 13 is discharged until the potential reaches 3 V (versus a lithium reference electrode).

LiₓNi_{1-y}M_{y}O_{2-z}X_{z} (1)

where:
M is at least one of titanium (Ti), vanadium (V), chromium (Cr), cobalt (Co), manganese (Mn), iron (Fe), copper (Cu), sodium (Na), magnesium (Mg), aluminum (Al), silicon (Si), tin (Sn), potassium (K), calcium (Ca), zinc (Zn), gallium (Ga), strontium (Sr), yttrium (Y), zirconium (Zr), niobium (Nb), molybdenum (Mo), barium (Ba), lanthanum (La), tungsten (W), boron (B), and combinations thereof;
X is at least one of fluorine (F), chlorine (Cl), bromine (Br), iodine (I), or sulfur (S); and
x, y, and z satisfy 0.8<x<1.2, 0≤y≤0.5, and 0≤z<0.05.

As is apparent from Formula (1), the layered rock-salt lithium-nickel composite oxide is a nickel-based lithium composite oxide. The layered rock-salt lithium-nickel composite oxide may further include one or more of first additional elements (M), and may further include one or more of second additional elements (X). Details on each of the first additional element (M) and the second additional element (X) are as described above.

In other words, as is apparent from a value range that y can take, the layered rock-salt lithium-nickel composite oxide may include no first additional element (M). Similarly, as is apparent from a value range that z can take, the layered rock-salt lithium-nickel composite oxide may include no second additional element (X).

The layered rock-salt lithium-nickel composite oxide is not limited to a particular kind as long as the layered rock-salt lithium-nickel composite oxide is a compound represented by Formula (1). Specific examples of the layered rock-salt lithium-nickel composite oxide include LiNiO₂, LiNi_{0.9}Co_{0.1}O₂, LiNi_{0.85}Co_{0.1}Al_{0.05}O₂, LiNi_{0.90}Co_{0.05}Al_{0.05}O₂, LiNi_{0.5}Co_{0.2}Mn_{0.3}O₂, LiNi_{0.8}Co_{0.1}Mn_{0.1}O₂, and LiNi_{0.9}Co_{0.05}Mn_{0.05}O₂.

It should be understood that the positive electrode material may include, for example, one or more of other lithium compounds together with the lithium compound (the layered rock-salt lithium-nickel composite oxide) described above. Examples of the other lithium compounds include another lithium composite oxide and a lithium phosphate compound.

The term “other lithium composite oxide” is a generic term for a composite oxide that includes, as constituent elements, lithium and one or more of other elements. The other lithium composite oxide has any of crystal structures including, without limitation, a layered rock-salt crystal structure and a spinel crystal structure, for example. However, a compound corresponding to the layered rock-salt lithium-nickel composite oxide is excluded from the other lithium composite oxide described here. The term “lithium phosphate compound” is a generic term for a phosphate compound that includes, as constituent elements, lithium and one or more of the other elements. The lithium phosphate compound has a crystal structure such as an olivine crystal structure, for example. Details of the other elements are as described above.

Examples of the other lithium composite oxide having the layered rock-salt crystal structure include LiCoO₂. Examples of the other lithium composite oxide having the spinel crystal structure include LiMn₂O₄. Examples of the lithium phosphate compound having the olivine crystal structure include LiFePO₄, LiMnPO₄, and LiMn_{0.5}Fe_{0.5}PO₄.

The positive electrode binder includes one or more of materials including, without limitation, a synthetic rubber and a polymer compound, for example. Examples of the synthetic rubber include a styrene-butadiene-based rubber. Examples of the polymer compound include polyvinylidene difluoride and polyimide.

The positive electrode conductor includes, for example, one or more of electrically conductive materials such as a carbon material. Examples of the carbon material include graphite, carbon black, acetylene black, and Ketjen black. The electrically conductive material may include a material such as a metal material or an electrically conductive polymer.

As illustrated in FIG. 3, the negative electrode 14 includes, for example, a negative electrode current collector 14A, and a negative electrode active material layer 14B provided on the negative electrode current collector 14A. The negative electrode active material layer 14B may be provided, for example, only on one side of the negative electrode current collector 14A, or on each of both sides of the negative electrode current collector 14A. FIG. 3 illustrates a case where the negative electrode active material layer 14B is provided on each of the both sides of the negative electrode current collector 14A, for example.

The negative electrode current collector 14A includes, for example, an electrically conductive material such as copper. It is preferable that the negative electrode current collector 14A have a surface roughened by a method such as an electrolysis method. A reason for this is that improved adherence of the negative electrode active material layer 14B to the negative electrode current collector 14A is achievable by utilizing a so-called anchor effect.

The negative electrode active material layer 14B includes, as a negative electrode active material or negative electrode active materials, one or more of negative electrode materials into which lithium ions are insertable and from which lithium ions are extractable. The negative electrode active material layer 14B may further include another material such as a negative electrode binder or a negative electrode conductor.

The negative electrode material includes a carbon material. The term “carbon material” is a generic term for a material mainly including carbon as a constituent element. A reason for this is that a high energy density is stably obtainable owing to the crystal structure of the carbon material which hardly varies upon insertion and extraction of lithium ions. Another reason is that improved electrical conductivity of the negative electrode active material layer 14B is achievable owing to the carbon material which also serves as the negative electrode conductor.

Specifically, the negative electrode material includes graphite. The graphite is not limited to a particular kind. The graphite may be artificial graphite, natural graphite, or both.

In a case where the negative electrode material includes a plurality of pieces of particulate graphite (a plurality of graphite particles), an average particle diameter (a median diameter D50) of the graphite particles is not particularly limited; however, the median diameter D50 is preferably from 3.5 μm to 30 μm both inclusive, and more preferably from 5 μm to 20 μm both inclusive. A reason for this is that precipitation of lithium metal is suppressed and occurrence of a side reaction is also suppressed. In detail, the median diameter D50 of smaller than 3.5 μm makes it easier for the side reaction to occur on surfaces of the graphite particles due to increased surface areas of the graphite particles, which may reduce an initial-cycle charge and discharge efficiency. In contrast, if the median diameter D50 is larger than 30 μm, gaps (vacancies) between graphite particles, which are flowing paths of the electrolytic solution, may be unevenly distributed, which may cause precipitation of lithium metal.

Here, it is preferable that some or all of the plurality of graphite particles form so-called secondary particles. A reason for this is that an orientation of the negative electrode 14 (the negative electrode active material layer 14B) is suppressed, thereby suppressing swelling of the negative electrode active material layer 14B upon charging and discharging. With respect to a weight of the plurality of graphite particles, a ratio of a weight occupied by a plurality of graphite particles forming the secondary particles is not particularly limited; however, the ratio is preferably from 20 wt % to 80 wt % both inclusive. If the ratio of graphite particles forming the secondary particles is relatively large, a total surface area of the particles is excessively increased due to a relatively small average particle diameter of primary particles, which may cause a decomposition reaction of the electrolytic solution to occur and a capacity per unit weight to be decreased.

In a case where graphite is analyzed by X-ray diffractometry (XRD), spacing of a graphene layer, having a graphite crystal structure, determined from a position of a peak derived from a (002) plane, that is, spacing S of the (002) plane, is preferably from 0.3355 nm to 0.3370 nm both inclusive, and more preferably from 0.3356 nm to 0.3363 nm both inclusive. A reason for this is that the decomposition reaction of the electrolytic solution is reduced while securing the battery capacity. In detail, if the spacing S is greater than 0.3370 nm, the battery capacity may be reduced due to inadequate graphitization of graphite. In contrast, if the spacing S is smaller than 0.3355 nm, a reactivity of the graphite to the electrolytic solution increases due to excessive graphitization of the graphite, which may cause the decomposition reaction of the electrolytic solution to occur.

The negative electrode material may include, for example, one or more of other materials together with the carbon material (graphite) described above. Examples of the other materials include another carbon material and a metal-based material. A reason for this is that the energy density further increases.

Examples of the other carbon material include non-graphitizable carbon. A reason for this is that a high energy density is stably achievable. A physical property of the non-graphitizable carbon is not particularly limited; however, in particular, spacing of the (002) plane is preferably greater than or equal to 0.37 nm. A reason for this is that a sufficient energy density is achievable.

The term “metal-based material” is a generic term for a material including, as a constituent element or constituent elements, one or more of: metal elements that are each able to form an alloy with lithium; and metalloid elements that are each able to form an alloy with lithium. The metal-based material may be a simple substance, an alloy, a compound, a mixture of two or more thereof, or a material including one or more phases thereof.

It should be understood that the simple substance described here merely refers to a simple substance in a general sense. The simple substance may therefore include a small amount of impurity, that is, does not necessarily have a purity of 100%. The term “alloy” encompasses, for example, not only a material that includes two or more metal elements but may also encompass a material that includes one or more metal elements and one or more metalloid elements. The alloy may further include one or more non-metallic elements. The metal-based material has a state such as a solid solution, a eutectic (a eutectic mixture), an intermetallic compound, or a state including two or more thereof that coexist, although not particularly limited thereto.

Specific examples of the metal element and the metalloid element include magnesium, boron, aluminum, gallium, indium, silicon, germanium, tin, lead, bismuth, cadmium, silver, zinc, hafnium, zirconium, yttrium, palladium, and platinum.

Among the above-described materials, a material including silicon as a constituent is preferable. Hereinafter, the material including silicon as a constituent is referred to as a “silicon-containing material”. A reason for this is that a markedly high energy density is obtainable owing to superior lithium-ion insertion capacity and superior lithium-ion extraction capacity thereof.

The silicon alloy includes, as a constituent element or constituent elements other than silicon, for example, one or more of tin, nickel, copper, iron, cobalt, manganese, zinc, indium, silver, titanium, germanium, bismuth, antimony, and chromium. The silicon compound includes, as a constituent element or constituent elements other than silicon, for example, one or both of carbon and oxygen. The silicon compound may include, as a constituent element or constituent elements other than silicon, one or more of the series of constituent elements described in relation to the silicon alloy, for example.

Specific examples of the silicon-containing material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, and a silicon oxide represented by Formula (3) below.

SiOᵥ (3)

where v satisfies 0.5≤v≤1.5.

In particular, the silicon oxide is preferable. A reason for this is that the silicon oxide has a relatively large capacity per unit weight and a relatively large capacity per unit volume in graphite ratios. Another reason is that, in the silicon oxide which includes oxygen, a structure thereof is stabilized by an oxygen-silicon bond and a lithium-oxygen bond after being lithiated, thereby suppressing cracking of the particles. The silicon oxide is not limited to a particular kind, and examples thereof include SiO.

Details of the negative electrode binder are similar to those of the positive electrode binder, for example. Details of the negative electrode conductor are similar to those of the positive electrode conductor, for example. However, the negative electrode binder may be, for example, a water-based (water-soluble) polymer compound. Examples of the water-soluble polymer compound include carboxymethyl cellulose and a metal salt thereof.

The separator 15 is interposed between the positive electrode 13 and the negative electrode 14, and causes the positive electrode 13 and the negative electrode 14 to be separated away from each other. The separator 15 includes a porous film of a material such as a synthetic resin or ceramic, for example. The separator 15 may be a stacked film including two or more porous films that are stacked on each other, in one example. Examples of the synthetic resin include polyethylene.

The electrolytic solution includes, for example, a solvent and an electrolyte salt. Only one solvent may be used, or two or more solvents may be used. Only one electrolyte salt may be used, or two or more electrolyte salts may be used.

The solvent includes one or more of non-aqueous solvents (organic solvents), for example. An electrolytic solution including the non-aqueous solvent is a so-called non-aqueous electrolytic solution.

The non-aqueous solvent is not limited to a particular kind, and examples thereof include a cyclic carbonate ester, a chain carbonate ester, a lactone, a chain carboxylate ester, and a nitrile (mononitrile) compound. A reason for this is that characteristics including, without limitation, a capacity characteristic, a cyclability characteristic, and a storage characteristic are secured.

Examples of the cyclic carbonate ester include ethylene carbonate and propylene carbonate. Examples of the chain carbonate ester include dimethyl carbonate and diethyl carbonate. Examples of the lactone include γ-butyrolactone and γ-valerolactone. Examples of the chain carboxylate ester include methyl acetate, ethyl acetate, methyl propionate, and propyl propionate. Examples of the nitrile compound include acetonitrile, methoxy acetonitrile, and 3-methoxy propionitrile.

Examples of the non-aqueous solvent further include an unsaturated cyclic carbonate ester, a halogenated carbonate ester, a sulfonate ester, an acid anhydride, a dicyano compound (a dinitrile compound), a diisocyanate compound, and a phosphate ester. A reason for this is that one or more of the above-described characteristics including, without limitation, a capacity characteristic are further improved.

Examples of the unsaturated cyclic carbonate ester include vinylene carbonate, vinyl ethylene carbonate, and methylene ethylene carbonate. The halogenated carbonate ester may be a cyclic halogenated carbonate ester or a chain halogenated carbonate ester. Examples of the halogenated carbonate ester include 4-fluoro-1,3-dioxolane-2-one, 4,5-difluoro-1,3-dioxolane-2-one, and fluoromethyl methyl carbonate. Examples of the sulfonate ester include 1,3-propane sultone and 1,3-propene sultone. Examples of the acid anhydride include succinic anhydride, glutaric anhydride, maleic anhydride, ethane disulfonic anhydride, propane disulfonic anhydride, sulfobenzoic anhydride, sulfopropionic anhydride, and sulfobutyric anhydride. Examples of the dinitrile compound include succinonitrile, glutaronitrile, adiponitrile, and phthalonitrile. Examples of the diisocyanate compound include hexamethylene diisocyanate. Examples of the phosphate ester include trimethyl phosphate and triethyl phosphate.

In particular, the solvent preferably includes the halogenated carbonate ester. A reason for this is that a film derived from the halogenated carbonate ester is provided on a surface of the negative electrode 14 upon charging and discharging, thereby protecting the surface of the negative electrode 14 by the film. This suppresses a decomposition reaction of the electrolytic solution on the surface of the negative electrode 14. Further, even if the precipitation of lithium metal occurs on the surface of the negative electrode 14, the lithium metal is prevented from reacting excessively with the electrolytic solution.

A content of the halogenated carbonate ester in the electrolytic solution is not particularly limited; however, the content is preferably from 1 wt % to 15 wt % both inclusive. A reason for this is that the decomposition reaction of the electrolytic solution is reduced and the reaction of the lithium metal with the electrolytic solution is suppressed, while securing the battery capacity, for example.

The halogenated carbonate ester is not limited to a particular kind; however, in particular, the halogenated carbonate ester is preferably a cyclic halogenated carbonate ester, and is more preferably 4-fluoro-1,3-dioxolane-2-one. A reason for this is that a film of a satisfactory quality is formed stably on the surface of the negative electrode 14.

The electrolyte salt includes one or more of lithium salts, for example. The electrolyte salt may further include one or more of light metal salts other than the lithium salt. The lithium salt is not limited to a particular kind, and examples thereof include lithium hexafluorophosphate (LiPF₆), lithium tetrafluoroborate (LiBF₄), lithium bis(fluorosulfonyl)imide (LiN(SO₂F)₂), lithium bis(trifluoromethane sulfonyl)imide (LiN(CF₃SO₂)₂), lithium fluorophosphate (Li₂PFO₃), lithium difluorophosphate (LiPF₂O₂), and lithium bis(oxalato)borate (LiC₄BO₈). A reason for this is that characteristics including, without limitation, a capacity characteristic, a cyclability characteristic, and a storage characteristic are secured.

A content of the electrolyte salt is, for example, greater than or equal to 0.3 mol/kg and less than or equal to 3.0 mol/kg with respect to the solvent, but is not particularly limited thereto.

The positive electrode lead 11 is coupled to the positive electrode 13, and is led out from inside to outside the outer package member 20. The positive electrode lead 11 includes, for example, an electrically conductive material such as aluminum. The positive electrode lead 11 has a shape such as a thin plate shape or a meshed shape, for example.

The negative electrode lead 12 is coupled to the negative electrode 14, and is led out from inside to outside the outer package member 20. A lead-out direction of the negative electrode lead 12 is, for example, similar to a lead-out direction of the positive electrode lead 11. The negative electrode lead 12 includes, for example, an electrically conductive material such as nickel. The negative electrode lead 12 has a shape similar to the shape of the positive electrode lead 11, for example.

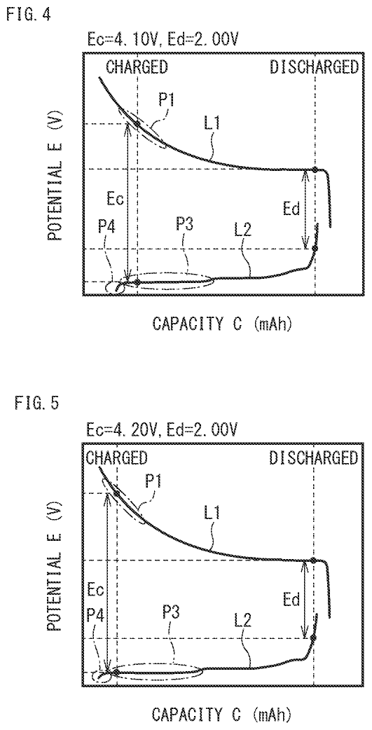

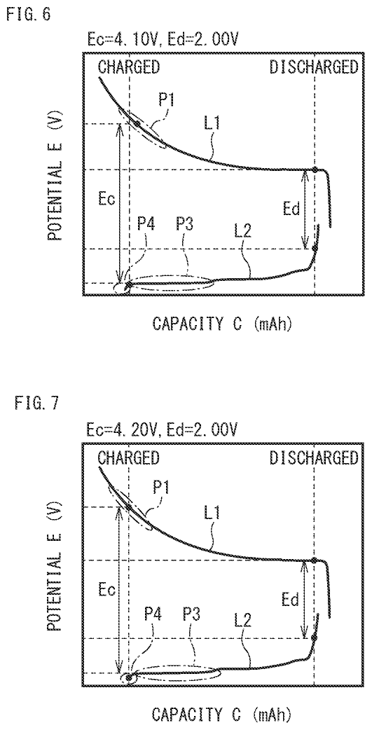

A charge and discharge principle and configuration conditions of the secondary battery of the embodiment will now be described. FIGS. 4 and 5 each represent a capacity potential curve related to a secondary battery according to a comparative example of the secondary battery according to the embodiment. FIGS. 6 and 7 each represent a capacity potential curve related to the secondary battery according to the embodiment.

In each of FIGS. 4 to 7, a horizontal axis represents a capacity C (mAh) and a vertical axis represents a potential E (V). The potential E is an open circuit potential to be measured with lithium metal as a reference electrode, i.e., a potential versus a lithium reference electrode. FIGS. 4 to 7 each indicate a charge and discharge curve L1 of the positive electrode 13 and a charge and discharge curve L2 of the negative electrode 14. It should be understood that a position of a dashed line indicated as “charged” represents a full charge state, and a position of a dashed line indicated as “discharged” represents a full discharge state.

A charge voltage Ec (V) and a discharge voltage Ed (V) are, for example, set as follows. In FIG. 4, the charge voltage Ec is set to 4.10 V and the discharge voltage Ed is set to 2.00 V. In FIG. 5, the charge voltage Ec is set to 4.20 V and the discharge voltage Ed is set to 2.00 V. In FIG. 6, the charge voltage Ec is set to 4.10 V and the discharge voltage Ed is set to 2.00 V. In FIG. 7, the charge voltage Ec is set to 4.20 V and the discharge voltage Ed is set to 2.00 V. Upon charging and discharging, the secondary battery is charged until a battery voltage (a closed circuit voltage) reaches the charge voltage Ec and then discharged until the battery voltage reaches the discharge voltage Ed.

In the following, a description is given of a premise for describing the charge and discharge principle and the configuration conditions of the secondary battery according to the embodiment. Thereafter, the charge and discharge principle and the configuration conditions for achieving the charge and discharge principle are described.

In order to improve an energy density of the secondary battery, it is conceivable to increase the charge voltage Ec (a so-called end-of-charge voltage). Increase in the charge voltage Ec raises a potential E of the positive electrode 13 in an end stage of charging, and by extension at an end of charging, which causes increase in a use range of the potential E, i.e., a potential range to be used in the positive electrode 13 during charging.

In a case where the layered rock-salt lithium-nickel composite oxide is used as the positive electrode active material, increase in the charge voltage Ec generally increases the potential E of the positive electrode 13. Accordingly, a capacity potential curve L1 of the positive electrode 13 has a potential varying region P1 as indicated in FIGS. 4 to 7. The potential varying region P1 is a region in which the potential E varies as the capacity C varies.

If, however, the charge voltage Ec is increased too much, the potential E of the positive electrode 13 in the end stage of charging reaches 4.30 V or higher. This causes so-called cation mixing to occur. The cation mixing is a phenomenon in which nickel ions are transferred to a site where the lithium ions should be present in the crystal structure of the positive electrode 13 (the layered rock-salt lithium-nickel composite oxide). When the cation mixing occurs, a change (a transition) in the crystal structure is promoted in the layered rock-salt lithium-nickel composite oxide, which causes a capacity loss to easily occur when charging and discharging are repeated. In particular, if the charge voltage Ec is 4.20 V or higher, the potential E of the positive electrode 13 reaches 4.30 V or higher, which makes it easier for the cation mixing to occur.

In contrast, if the charge voltage Ec is increased in a case where graphite is used as the negative electrode active material, a two-phase coexistence reaction of an intercalation compound stage 1 and an interlayer compound stage 2 proceeds in the graphite. As a result, a capacity potential curve L2 of the negative electrode 14 has a potential constant region P3 as indicated in FIGS. 4 to 7. The potential constant region P3 is a region in which the potential E hardly varies even if the capacity C varies in association with the two-phase coexistence reaction. A potential E of the negative electrode 14 in the potential constant region P3 is about 90 mV to about 100 mV.

It should be understood that if the charge voltage Ec is further increased, the potential E of the negative electrode 14 exceeds the potential constant region P3, and thus the potential E varies markedly. In association therewith, the capacity potential curve L2 of the negative electrode 14 has a potential varying region P4, as indicated in FIGS. 4 to 7. In FIGS. 4 to 7, the potential varying region P4 is a region located on a lower potential side compared with the potential constant region P3 in the capacity potential curve, and is a region in which the potential E markedly varies if the capacity C varies. The potential E of the negative electrode 14 in the potential varying region P4 is lower than about 90 mV.

In the secondary battery according to the embodiment in which the positive electrode 13 includes the positive electrode active material (the layered rock-salt lithium-nickel composite oxide) and the negative electrode 14 includes the negative electrode active material (graphite), charging and discharging are performed as described below on the basis of the premise described above. In the following, the charge and discharge principle of the secondary battery according to the embodiment (FIGS. 6 and 7) will be described, compared with the charge and discharge principle of the secondary battery according to the comparative example (FIGS. 4 and 5).

In the secondary battery according to the comparative example, as indicated in FIG. 4, the potential E of the negative electrode 14 at the end of charging (charge voltage Ec=4.10 V) is set to cause the charging to be completed in the potential constant region P3, in order to prevent a battery capacity from decreasing due to precipitation of lithium metal on the negative electrode 14.

However, in a case where the charge voltage Ec of the secondary battery according to the comparative example is increased to 4.20 V or higher, the potential E of the positive electrode 13 reaches 4.30 V or higher as indicated in FIG. 5 in association with the increase in the potential E of the negative electrode 14 at the end of charging.

Thus, in the secondary battery according to the comparative example, the increase in the charge voltage Ec to 4.20 V or higher makes it easier for the cation mixing to occur on the positive electrode 13 (the layered rock-salt lithium-nickel composite oxide) as described above. As a result, the capacity loss easily occurs, making it easier to deteriorate battery characteristics. The tendency that the battery characteristics easily deteriorate becomes relatively strong when the secondary battery is used and stored in a high temperature environment.

In contrast, in the secondary battery according to the embodiment, the potential E of the negative electrode 14 is set to suppress occurrence of the cation mixing on the positive electrode 13 (the layered rock-salt lithium-nickel composite oxide) and also to suppress the precipitation of lithium metal on the negative electrode 14. Specifically, as indicated in FIG. 6, the potential E of the negative electrode 14 at the end of charging (charge voltage Ec=4.10 V) is set to cause the charging not to be completed in the potential constant region P3 and to be completed in the potential varying region P4. Further, as indicated in FIG. 7, the potential E of the negative electrode 14 at the end of charging (charge voltage Ec=4.20 V) is similarly set to cause the charging not to be completed in the potential constant region P3 and to be completed in the potential varying region P4.

In this case, because the potential E of the negative electrode 14 at the end of charging decreases, the potential E of the positive electrode 13 at the end of charging also decreases. Specifically, in the secondary battery according to the embodiment, the potential E of the positive electrode 13 does not reach 4.30 V or above even if the charge voltage Ec is increased to 4.20 V or higher, as indicated in FIGS. 6 and 7, in association with the decrease in the potential E of the negative electrode 14 at the end of charging.

Upon charging, as is apparent from FIGS. 6 and 7, when the secondary battery is charged up to the charge voltage Ec of 4.20 V or higher, the potential E of the negative electrode 14 markedly decreases in the potential varying region P4, and thus a charging reaction is completed. Thus, the potential E of the positive electrode 13 is controlled at the end stage of charging in such a manner as not to excessively increase, which suppresses occurrence of the cation mixing in the layered rock-salt lithium-nickel composite oxide. In addition, if the potential E of the negative electrode 14 markedly decreases in the potential varying region P4, the charging reaction is immediately terminated. This prevents the charging reaction from proceeding to an extent where the precipitation of lithium metal occurs on the negative electrode 14.

Accordingly, in the secondary battery according to the embodiment, even if the charge voltage Ec is increased to 4.20 V or higher, occurrence of the cation mixing on the positive electrode 13 is suppressed. As a result, the capacity loss is relatively suppressed. In addition, even if the charge voltage Ec is increased to 4.20 V or higher, the precipitation of lithium metal is suppressed on the negative electrode 14, which suppresses decrease in the battery capacity.

In the secondary battery according to the embodiment, two configuration conditions described below are satisfied in order to achieve the charge and discharge principle described above.

First, a state in which the secondary battery is charged with a constant voltage of a closed circuit voltage (CCV) of 4.20 V or higher for 24 hours is referred to as a full charge state. A potential E (a negative electrode potential Ef) of the negative electrode 14 measured in the secondary battery in the full charge state is from 19 mV to 86 mV both inclusive. It should be understood that a value of a current at the time of charging the secondary battery until the closed circuit voltage reaches 4.20 V or higher is not particularly limited, and may thus be set to any value.

That is, as described above, the potential E of the negative electrode 14 is set to cause the charging not to be completed in the potential constant region P3 and to be completed in the potential varying region P4. Accordingly, when the secondary battery is charged to the full charge state, the negative electrode potential Ef is lower in a case where the charging is completed in the potential varying region P4 than in a case where the charging is completed in the potential constant region P3. Thus, the negative electrode potential Ef becomes lower than about 90 mV, and more specifically, from 19 mV to 86 mV both inclusive, as described above.

Secondly, a discharge capacity obtained when the secondary battery is discharged with a constant current from the full charge state until a closed circuit voltage reaches 2.00 V, following which the secondary battery is discharged with a constant voltage of the closed circuit voltage of 2.00 V for 24 hours is referred to as a maximum discharge capacity (mAh). In this case, when the secondary battery is discharged from the full charge state by a capacity corresponding to 1% of the maximum discharge capacity, a variation of the potential E of the negative electrode 14, i.e., a negative electrode potential variation Ev, represented by Formula (2) below is 1 mV or greater. As is apparent from Formula (2), the negative electrode potential variation Ev is a difference between a potential E1 (a first negative electrode potential) and a potential E2 (a second negative electrode potential). It should be understood that the current value at the time of discharging the secondary battery from the full charge state until the closed circuit voltage reaches 2.00 V is not particularly limited and may be set to any value as long as the current value is within a general range, because the secondary battery is discharged with a constant voltage for 24 hours.

Negative electrode potential variation Ev (mV)=potential E2 (mV)−potential E1 (mV) (2)

where:
the potential E1 is an open circuit potential (versus a lithium reference electrode) of the negative electrode 14 measured in the secondary battery in the full charge state; and
the potential E2 is an open circuit potential (versus a lithium reference electrode) of the negative electrode 14 measured in the secondary battery in a state in which the secondary battery is discharged from the full charge state by the capacity corresponding to 1% of the maximum discharge capacity.

That is, as described above, in a case where the potential E of the negative electrode 14 is set to cause the charging to be completed in the potential varying region P4, the potential E of the negative electrode 14 increases markedly upon discharging the secondary battery in the full charge state by the capacity corresponding to 1% of the maximum discharge capacity, as is apparent from FIGS. 6 and 7. Thus, the potential E (E2) of the negative electrode 14 after the discharging is sufficiently increased as compared with the potential E (E1) of the negative electrode 14 before the discharging (the full charge state). Accordingly, the negative electrode potential variation Ev, which is the difference between the potential E1 and the potential E2, is 1 mV or greater as described above.

The secondary battery according to the embodiment operates as follows, for example. Upon charging the secondary battery, lithium ions are extracted from the positive electrode 13, and the extracted lithium ions are inserted into the negative electrode 14 via the electrolytic solution. Upon discharging the secondary battery, lithium ions are extracted from the negative electrode 14, and the extracted lithium ions are inserted into the positive electrode 13 via the electrolytic solution.

In a case of manufacturing the secondary battery according to the embodiment, the positive electrode 13 and the negative electrode 14 are fabricated and thereafter the secondary battery is assembled using the positive electrode 13 and the negative electrode 14, for example, as described below.

First, the positive electrode active material including the layered rock-salt lithium-nickel composite oxide is mixed with materials including, without limitation, the positive electrode binder and the positive electrode conductor on an as-needed basis to thereby obtain a positive electrode mixture. Thereafter, the positive electrode mixture is dispersed or dissolved into a solvent such as an organic solvent to thereby prepare a paste positive electrode mixture slurry. Lastly, the positive electrode mixture slurry is applied on both sides of the positive electrode current collector 13A, following which the applied positive electrode mixture slurry is dried to thereby form the positive electrode active material layers 13B. Thereafter, the positive electrode active material layers 13B may be compression-molded by means of a machine such as a roll pressing machine. In this case, the positive electrode active material layers 13B may be heated. The positive electrode active material layers 13B may be compression-molded a plurality of times.

The negative electrode active material layers 14B are provided on both sides of the negative electrode current collector 14A by a procedure similar to the fabrication procedure of the positive electrode 13 described above. Specifically, the negative electrode active material including graphite is mixed with materials including, without limitation, the negative electrode binder and the negative electrode conductor on an as-needed basis to thereby obtain a negative electrode mixture. Thereafter, the negative electrode mixture is dispersed or dissolved into a solvent such as an organic solvent or an aqueous solvent to thereby prepare a paste negative electrode mixture slurry. Thereafter, the negative electrode mixture slurry is applied on both sides of the negative electrode current collector 14A, following which the applied negative electrode mixture slurry is dried to thereby form the negative electrode active material layers 14B. Thereafter, the negative electrode active material layers 14B may be compression-molded.

In the case of fabricating the positive electrode 13 and the negative electrode 14, a mixture ratio between the positive electrode active material and the negative electrode active material (a relationship between mass of the positive electrode active material and mass of the negative electrode active material) is adjusted in such a manner that the mass of the positive electrode active material is sufficiently greater, to thereby satisfy the above-described two configuration conditions (the negative electrode potential Ef and the negative electrode potential variation Ev).

First, the positive electrode lead 11 is coupled to the positive electrode 13 (the positive electrode current collector 13A) by a method such as a welding method, and the negative electrode lead 12 is coupled to the negative electrode 14 (the negative electrode current collector 14A) by a method such as a welding method. Thereafter, the positive electrode 13 and the negative electrode 14 are stacked on each other with the separator 15 interposed therebetween, following which the positive electrode 13, the negative electrode 14, and the separator 15 are wound to thereby form a wound body. In this case, an unillustrated jig having an elongated shape is used to wind the positive electrode 13, the negative electrode 14, and the separator 15 about the winding axis J to thereby cause the wound body to be in the elongated shape as illustrated in FIG. 1.

Thereafter, the outer package member 20 is folded in such a manner as to sandwich the wound electrode body 10, following which the outer edges excluding one side of the outer package member 20 are bonded to each other by a method such as a thermal fusion bonding method. Thus, the wound body is contained in the pouch-shaped outer package member 20. Lastly, the electrolytic solution is injected into the pouch-shaped outer package member 20, following which the outer package member 20 is sealed by a method such as a thermal fusion bonding method. In this case, the sealing film 31 is disposed between the outer package member 20 and the positive electrode lead 11, and the sealing film 32 is disposed between the outer package member 20 and the negative electrode lead 12. The wound body is thereby impregnated with the electrolytic solution, forming the wound electrode body 10. Thus, the wound electrode body 10 is contained in the outer package member 20. As a result, the secondary battery is completed.

According to the secondary battery, in a case where the positive electrode 13 includes the positive electrode active material (the layered rock-salt lithium-nickel composite oxide) and where the negative electrode 14 includes the negative electrode active material (graphite), the above-described two configuration conditions (the negative electrode potential Ef and the negative electrode potential variation Ev) are satisfied. In this case, as compared with the case where the two configuration conditions are not satisfied, even if the charge voltage Ec is increased to 4.20 V or higher: the occurrence of the cation mixing on the positive electrode 13 is suppressed; and precipitation of lithium metal is suppressed on the negative electrode 14. As a result, the capacity loss is suppressed and the decrease in the battery capacity is also suppressed. Accordingly, it is possible to achieve superior battery characteristics.

In particular, the median diameter D50 of the graphite particles may be from 3.5 μm to 30 μm both inclusive. This suppresses the precipitation of lithium metal and also suppresses the occurrence of the side reaction, making it possible to achieve higher effects accordingly.

Further, the spacing S of the (002) plane of graphite may be from 0.3355 nm to 0.3370 nm both inclusive. This reduces the decomposition reaction of the electrolytic solution while securing the battery capacity, which makes it possible to achieve higher effects accordingly.

Still further, the electrolytic solution may include the halogenated carbonate ester, and the content of the halogenated carbonate ester in the electrolytic solution may be from 1 wt % to 15 wt % both inclusive. This suppresses the decomposition reaction of the electrolytic solution on the surface of the negative electrode 14, and suppresses the reaction of the lithium metal precipitated on the surface of the negative electrode 14 with the electrolytic solution, which makes it possible to achieve higher effects accordingly.

Moreover, the negative electrode 14 may further include non-graphitizable carbon, a silicon-containing material, or both. This increases the energy density, which makes it possible to achieve higher effects accordingly. In this case, the silicon-containing material may include silicon oxide. This prevents the negative electrode active material from cracking easily while securing, for example, a capacity per unit mass, making it possible to achieve further higher effects accordingly.

The configurations of the secondary batteries described above are appropriately modifiable as described below. It should be understood that any two or more of the following series of modifications may be combined.

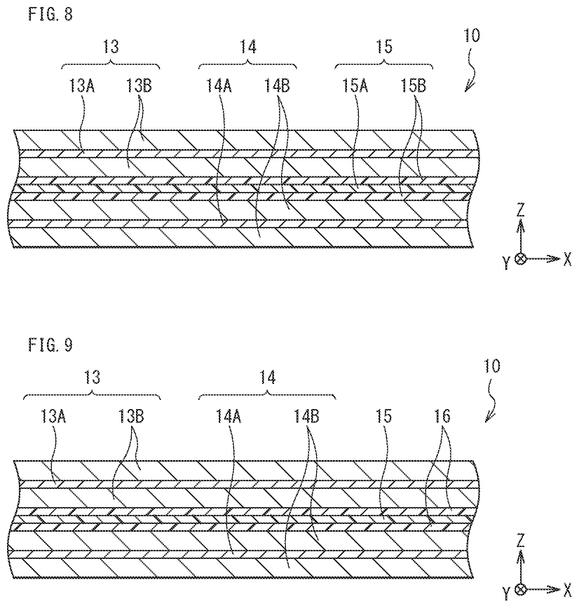

FIG. 8 illustrates a sectional configuration of a secondary battery (the wound electrode body 10) of Modification 1, and corresponds to FIG. 3. As illustrated in FIG. 8, the separator 15 may include, for example, the base layer 15A and the polymer compound layer 15B provided on the base layer 15A. The polymer compound layer 15B may be provided on only one side of the base layer 15A, or on each of both sides of the base layer 15A. FIG. 8 illustrates a case where the polymer compound layer 15B is provided on each of the both sides of the base layer 15A, for example.

The base layer 15A is, for example, the porous film described above. The polymer compound layer 15B includes, for example, a polymer compound such as polyvinylidene difluoride, because such a polymer compound has superior physical strength and is electrochemically stable. It should be understood that the polymer compound layer may include insulating particles such as inorganic particles. A reason for this is that safety improves. The insulating particles are not limited to a particular kind, and examples thereof include aluminum oxide and aluminum nitride.

In a case of fabricating the separator 15, for example, a precursor solution that includes materials including, without limitation, the polymer compound and an organic solvent is prepared to thereby apply the precursor solution on each of both sides of the base layer 15A. Thereafter, the precursor solution is dried to thereby form the polymer compound layer 15B.

Also in this case, similar effects are obtainable by satisfying the above-described two configuration conditions (the negative electrode potential Ef and the negative electrode potential variation Ev). In particular, adherence of the separator 15 to the positive electrode 13 is improved and adherence of the separator 15 to the negative electrode 14 is improved, suppressing distortion of the wound electrode body 10. This suppresses a decomposition reaction of the electrolytic solution and also suppresses leakage of the electrolytic solution with which the base layer 15A is impregnated, making it possible to achieve higher effects accordingly.

FIG. 9 illustrates a sectional configuration of a secondary battery (the wound electrode body 10) of Modification 3, and corresponds to FIG. 3. As illustrated in FIG. 9, the wound electrode body 10 may include, for example, an electrolyte layer 16 which is a gel electrolyte instead of an electrolytic solution which is a liquid electrolyte.

As illustrated in FIG. 9, in the wound electrode body 10, the positive electrode 13 and the negative electrode 14 are stacked with the separator 15 and the electrolyte layer 16 interposed therebetween, and the positive electrode 13, the negative electrode 14, the separator 15, and the electrolyte layer 16 are wound, for example. The electrolyte layer 16 is interposed, for example, between the positive electrode 13 and the separator 15, and between the negative electrode 14 and the separator 15. However, the electrolyte layer 16 may be interposed only between the positive electrode 13 and the separator 15 or only between the negative electrode 14 and the separator 15.

The electrolyte layer 16 includes a polymer compound together with the electrolytic solution. As described above, the electrolyte layer 16 described here is the gel electrolyte; thus, the electrolytic solution is held by the polymer compound in the electrolyte layer 16. A configuration of the electrolytic solution is as described above. Regarding the electrolyte layer 16 which is the gel electrolyte, the concept of the solvent included in the electrolytic solution is broad and encompasses not only a liquid material but also an ion-conductive material that is able to dissociate the electrolyte salt. Accordingly, the ion-conductive polymer compound is also encompassed by the solvent. The polymer compound includes, for example, a homopolymer, a copolymer, or both. Examples of the homopolymer include polyvinylidene difluoride. Examples of the copolymer include a copolymer of vinylidene fluoride and hexafluoropyrene.

In a case of forming the electrolyte layer 16, for example, a precursor solution that includes materials including, without limitation, the electrolytic solution, the polymer compound, and an organic solvent is prepared to thereby apply the precursor solution on each of the positive electrode 13 and the negative electrode 14, following which the precursor solution is dried.

Also in this case, similar effects are obtainable by satisfying the above-described two configuration conditions (the negative electrode potential Ef and the negative electrode potential variation Ev). In particular, this case suppresses leakage of the electrolytic solution, making it possible to achieve higher effects accordingly.

The applications of the secondary battery are not particularly limited as long as they are, for example, machines, apparatuses, instruments, devices, or systems (assembly of a plurality of apparatuses, for example) in which the secondary battery is usable as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic apparatuses including portable electronic apparatuses; portable life appliances; storage devices; electric power tools; battery packs mountable on laptop personal computers or other apparatuses as a detachable power source; medical electronic apparatuses; electric vehicles; and electric power storage systems. Examples of the electronic apparatuses include video cameras, digital still cameras, mobile phones, laptop personal computers, cordless phones, headphone stereos, portable radios, portable televisions, and portable information terminals. Examples of the portable life appliances include electric shavers. Examples of the storage devices include backup power sources and memory cards. Examples of the electric power tools include electric drills and electric saws. Examples of the medical electronic apparatuses include pacemakers and hearing aids. Examples of the electric vehicles include electric automobiles including hybrid automobiles. Examples of the electric power storage systems include home battery systems for accumulation of electric power for emergency. Needless to say, the secondary battery may have applications other than those described above.

### EXAMPLES

A description is given of Examples of the technology below.

### Experiment Examples 1-1 to 1-10

Laminated secondary batteries (lithium-ion secondary batteries) illustrated in FIGS. 1 and 2 were fabricated, following which battery characteristics of the secondary batteries were evaluated as described below.

In a case of fabricating the positive electrode 13, first, 91 parts by mass of the positive electrode active material (LiNi_{0.5}Co_{0.2}Mn_{0.3}O₂ serving as the layered rock-salt lithium-nickel composite oxide), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on both sides of the positive electrode current collector 13A (a band-shaped aluminum foil having a thickness of 12 μm) by means of a coating apparatus, following which the applied positive electrode mixture slurry was dried to thereby form the positive electrode active material layers 13B. Lastly, the positive electrode active material layers 13B were compression-molded by means of a roll pressing machine.

In a case of fabricating the negative electrode 14, first, 97 parts by mass of the negative electrode active material (artificial graphite having a median diameter D50 of 10 μm and spacing S of the (002) plane of 0.3360 μm), and 1.5 parts by mass of the negative electrode binder (sodium carboxymethyl cellulose) were mixed with each other to thereby obtain a negative electrode mixture precursor. Thereafter, the negative electrode mixture precursor was put into an aqueous solvent (deionized water), following which 1.5 parts by mass, in terms of solid content, of the negative electrode binder (a styrene-butadiene-rubber dispersion liquid) was put into the aqueous solvent to thereby prepare a paste negative electrode mixture slurry. Thereafter, the negative electrode mixture slurry was applied on both sides of the negative electrode current collector 14A (a band-shaped copper foil having a thickness of 15 μm) by means of a coating apparatus, following which the applied negative electrode mixture slurry was dried to thereby form the negative electrode active material layers 14B. Lastly, the negative electrode active material layers 14B were compression-molded by means of a roll pressing machine.

In the case of fabricating the positive electrode 13 and the negative electrode 14, a mixture ratio (a weight ratio) between the positive electrode active material and the negative electrode active material was adjusted to thereby vary each of the negative electrode potential Ef (mV) and the negative electrode potential variation Ev (mV). Each of the negative electrode potential Ef and the negative electrode potential variation Ev in the case where the charge voltage Ec was set to 4.20 V was as described in Table 1. Here, the maximum discharge capacity was set to 1950 mAh to 2050 mAh both inclusive.

In a case of preparing the electrolytic solution, the electrolyte salt (lithium hexafluorophosphate) was added to a solvent (ethylene carbonate, propylene carbonate, and diethyl carbonate), following which the solvent was stirred. In this case, a mixture ratio (a weight ratio) of ethylene carbonate/propylene carbonate/diethyl carbonate in the solvent was set to 15:15:70, and a content of the electrolyte salt with respect to the solvent was set to 1.2 mol/kg.

In a case of assembling the secondary battery, first, the positive electrode lead 11 including aluminum was welded to the positive electrode current collector 13A, and the negative electrode lead 12 including copper was welded to the negative electrode current collector 14A. Thereafter, the positive electrode 13 and the negative electrode 14 were stacked on each other with the separator 15 (a fine-porous polyethylene film having a thickness of 15 μm) interposed therebetween to thereby obtain a stacked body. Thereafter, the stacked body was wound, following which the protective tape was attached to a surface of the stacked body to thereby obtain a wound body.

Thereafter, the outer package member 20 was folded in such a manner as to sandwich the wound body, following which the outer edges of two sides of the outer package member 20 were thermal fusion bonded to each other. As the outer package member 20, an aluminum laminated film was used in which a surface protective layer (a nylon film having a thickness of 25 μm), a metal layer (an aluminum foil having a thickness of 40 μm), and a fusion-bonding layer (a polypropylene film having a thickness of 30 μm) were stacked in this order. In this case, the sealing film 31 (a polypropylene film having a thickness of 5 μm) was interposed between the outer package member 20 and the positive electrode lead 11, and the sealing film 32 (a polypropylene film having a thickness of 5 μm) was interposed between the outer package member 20 and the negative electrode lead 12.

Lastly, the electrolytic solution was injected into the outer package member 20 and thereafter, the outer edges of one of the remaining sides of the outer package member 20 were thermal fusion bonded to each other in a reduced-pressure environment. Thus, the wound body was impregnated with the electrolytic solution, thereby forming the wound electrode body 10 and sealing the wound electrode body 10 in the outer package member 20. As a result, the laminated secondary battery was completed.

Evaluation of battery characteristics of the secondary batteries revealed the results described in Table 1. A load characteristic and an electric resistance characteristic were evaluated here as the battery characteristics.

In a case of examining the load characteristic, first, the secondary battery was charged and discharged for one cycle in an ambient temperature environment (at a temperature of 23° C.) in order to stabilize a state of the secondary battery. Upon charging, the secondary battery was charged with a constant current of 0.2 C until a battery voltage reached the charge voltage Ec (4.20 V), and was thereafter charged with a constant voltage of the battery voltage corresponding to the charge voltage Ec until a current reached 0.05 C. Upon discharging, the secondary battery was discharged with a constant current of 0.2 C until a battery voltage reached the discharge voltage Ed (2.00 V). It should be understood that 0.2 C and 0.05 C are values of currents that cause battery capacities (theoretical capacities) to be completely discharged in 5 hours and 20 hours, respectively.

Thereafter, the secondary battery was charged and discharged for another cycle in the same environment to thereby measure a second-cycle discharge capacity. Charging and discharging conditions were similar to the charging and discharging conditions at the first cycle.

Thereafter, the secondary battery was charged and discharged for another cycle in the same environment to thereby measure a third-cycle discharge capacity. Charging and discharging conditions were similar to the charging and discharging conditions at the first cycle except that the current at the time of discharging was changed to 2 C. It should be understood that 2 C is a value of current that causes a battery capacity (a theoretical capacity) to be completely discharged in 0.5 hours.

Lastly, the following was calculated: load retention rate (%)=(third-cycle discharge capacity/second-cycle discharge capacity)×100.

In a case of examining the electric resistance characteristic, the state of the secondary battery was stabilized by the above procedures. Thereafter, first, the secondary battery was charged and discharged for one cycle in an ambient temperature environment (at a temperature of 23° C.) to thereby measure an electric resistance (a second-cycle electric resistance). Thereafter, the secondary battery was charged and discharged for another 200 cycles in a high temperature environment (at a temperature of 45° C.) to thereby measure an electric resistance (a 202nd-cycle electric resistance). Lastly, the following was calculated: resistance increase rate (%)=[(202nd-cycle thickness−second-cycle thickness)/second-cycle thickness]×100. Charging and discharging conditions were similar to the charging and discharging conditions at the first cycle.

TABLE 1

| | | | | | Negative | | |
|---|---|---|---|---|---|---|---|
| | | Negative | | Negative | electrode | | |
| | | electrode | Charge | electrode | potential | Load | Resistance |
| Experiment | Positive electrode | active | voltage | potential | variation | retention | increase |
| example | active material | material | Ec (V) | Ef (mV) | Ev (mV) | rate (%) | rate (%) |
| 1-1 | LiNi_{0.5}Co_{0.2}Mn_{0.3}O₂ | Artificial | 4.20 | 86 | 1 | 91 | 22 |
| 1-2 | | graphite | | 80 | 3 | 88 | 17 |
| 1-3 | | | | 68 | 9 | 90 | 11 |
| 1-4 | | | | 50 | 17 | 90 | 11 |
| 1-5 | | | | 19 | 28 | 88 | 7 |
| 1-6 | LiNi_{0.5}Co_{0.2}Mn_{0.3}O₂ | Artificial | 4.20 | 12 | 15 | 90 | 40 |
| 1-7 | | graphite | | 87 | <1 | 92 | 42 |
| 1-8 | | | | 88 | <1 | 91 | 48 |
| 1-9 | | | | 90 | <1 | 91 | 55 |
| 1-10 | | | | 91 | <1 | 91 | 60 |

As described in Table 1, in the case where the positive electrode 13 included the positive electrode active material (the layered rock-salt lithium-nickel composite oxide) and the negative electrode 14 included the negative electrode active material particles (graphite), and where the charge voltage Ec was set to higher than or equal to 4.20 V, each of the load retention rate and the resistance increase rate varied depending on the negative electrode potential Ef and the negative electrode potential variation Ev.

Specifically, in a case where two configuration conditions, i.e., the negative electrode potential Ef being from 19 mV to 86 mV both inclusive and the negative electrode potential variation Ev being greater than or equal to 1 mV, were satisfied together (Experiment examples 1-1 to 1-5), the resistance increase rate decreased while retaining a substantially equal high load retention rate, as compared with a case where the two configuration conditions were not satisfied together (Experiment examples 1-6 to 1-10).

### Experiment Examples 2-1 to 2-10, 3-1 to 3-10, and 4-1 to 4-10

As described in Tables 2 to 4, secondary batteries were fabricated following which the battery characteristics of the secondary batteries were examined by similar procedures except that the kind of the positive electrode active material was changed. LiNi_{0.8}Co_{0.1}Mn_{0.1}O₂ and LiNi_{0.85}Co_{0.1}Al_{0.05}O₂, which are each a layered rock-salt lithium-nickel composite oxide, were newly used as the positive electrode active material. For comparison, a lithium compound (LiNi_{0.33}Co_{0.33}Mn_{0.33}O₂), which does not correspond to the layered rock-salt lithium-nickel composite oxide, was also used.

TABLE 2

| | | | | | Negative | | |
|---|---|---|---|---|---|---|---|
| | | Negative | | Negative | electrode | | |
| | | electrode | Charge | electrode | potential | Load | Resistance |
| Experiment | Positive electrode | active | voltage | potential | variation | retention | increase |
| example | active material | material | Ec (V) | Ef (mV) | Ev (mV) | rate (%) | rate (%) |
| 2-1 | LiNi_{0.8}Co_{0.1}Mn_{0.1}O₂ | Artificial | 4.20 | 86 | 1 | 88 | 18 |
| 2-2 | | graphite | | 80 | 3 | 89 | 13 |
| 2-3 | | | | 68 | 9 | 92 | 10 |
| 2-4 | | | | 50 | 17 | 88 | 8 |
| 2-5 | | | | 19 | 28 | 89 | 7 |
| 2-6 | LiNi_{0.8}Co_{0.1}Mn_{0.1}O₂ | Artificial | 4.20 | 12 | 15 | 90 | 39 |
| 2-7 | | graphite | | 87 | <1 | 89 | 45 |
| 2-8 | | | | 88 | <1 | 90 | 59 |
| 2-9 | | | | 90 | <1 | 91 | 66 |
| 2-10 | | | | 91 | <1 | 88 | 76 |

TABLE 3

| | | | | | Negative | | |
|---|---|---|---|---|---|---|---|
| | | Negative | | Negative | electrode | | |
| | | electrode | Charge | electrode | potential | Load | Resistance |
| Experiment | Positive electrode | active | voltage | potential | variation | retention | increase |
| example | active material | material | Ec (V) | Ef (mV) | Ev (mV) | rate (%) | rate (%) |
| 3-1 | LiNi_{0.85}Co_{0.1}Al_{0.05}O₂ | Artificial | 4.20 | 86 | 1 | 88 | 18 |
| 3-2 | | graphite | | 80 | 3 | 90 | 16 |
| 3-3 | | | | 68 | 9 | 91 | 11 |
| 3-4 | | | | 50 | 17 | 88 | 10 |
| 3-5 | | | | 19 | 28 | 91 | 6 |
| 3-6 | LiNi_{0.85}Co_{0.1}Al_{0.05}O₂ | Artificial | 4.20 | 12 | 15 | 89 | 41 |
| 3-7 | | graphite | | 87 | <1 | 89 | 48 |
| 3-8 | | | | 88 | <1 | 91 | 65 |
| 3-9 | | | | 90 | <1 | 90 | 70 |
| 3-10 | | | | 91 | <1 | 90 | 78 |

TABLE 4

| | | | | | Negative | | |
|---|---|---|---|---|---|---|---|
| | | Negative | | Negative | electrode | | |
| | | electrode | Charge | electrode | potential | Load | Resistance |
| Experiment | Positive electrode | active | voltage | potential | variation | retention | increase |
| example | active material | material | Ec (V) | Ef (mV) | Ev (mV) | rate (%) | rate (%) |
| 4-1 | LiNi_{0.33}Co_{0.33}Mn_{0.33}O₂ | Artificial | 4.20 | 86 | 1 | 71 | 21 |
| 4-2 | | graphite | | 80 | 3 | 69 | 15 |
| 4-3 | | | | 68 | 9 | 71 | 14 |
| 4-4 | | | | 50 | 17 | 69 | 12 |
| 4-5 | | | | 19 | 28 | 68 | 6 |
| 4-6 | LiNi_{0.33}Co_{0.33}Mn_{0.33}O₂ | Artificial | 4.20 | 12 | 15 | 71 | 24 |
| 4-7 | | graphite | | 87 | <1 | 68 | 24 |
| 4-8 | | | | 88 | <1 | 71 | 25 |
| 4-9 | | | | 90 | <1 | 71 | 27 |
| 4-10 | | | | 91 | <1 | 72 | 28 |

As described in Tables 2 and 3, similar results as those in Table 1 were obtained also in the case of changing the kind of the positive electrode active material (the layered rock-salt lithium-nickel composite oxide). That is, in the case where the above-described two configuration conditions (the negative electrode potential Ef and the negative electrode potential variation Ev) were satisfied (Experiment examples 2-1 to 2-5 and 3-1 to 3-5), the resistance increase rate decreased while retaining a substantially equal high load retention rate, as compared with the case where the two configuration conditions were not satisfied (Experiment Examples 2-6 to 2-10 and 3-6 to 3-10).

In contrast, as described in Table 4, in the case where the lithium compound which does not correspond to the layered rock-salt lithium-nickel composite oxide was used, a high load retention rate was unobtainable, and the resistance increase rate did not sufficiently decrease regardless of whether the two configuration conditions (the negative electrode potential Ef and the negative electrode potential variation Ev) were satisfied.

### Experiment Examples 5-1 to 5-6

As described in Table 5, secondary batteries were fabricated following which the battery characteristics of the secondary batteries were examined by similar procedures except that the configuration of the negative electrode 14 (the median diameter D50 (μm) of the negative electrode active material (artificial graphite)) was changed, and that a low-temperature cyclability characteristic was newly evaluated.

In a case of examining the low-temperature cyclability characteristic, the state of the secondary battery was stabilized by the above procedures, following which the secondary battery was charged and discharged for one cycle in an ambient temperature environment (at a temperature of 23° C.) to thereby measure the second-cycle discharge capacity. Thereafter, the secondary battery was charged and discharged for another 100 cycles in a low temperature environment (at a temperature of 0° C.) to thereby measure a 102nd-cycle discharge capacity. Lastly, the following was calculated: low-temperature retention rate (%)=(102nd-cycle discharge capacity/second-cycle discharge capacity)×100. Charging and discharging conditions were similar to the charging and discharging conditions at the first cycle in the case of examining the load characteristic, except that the current at the time of charging was changed to 0.5 C and that the current at the time of discharging was changed to 0.5 C.

TABLE 5

| | | | | Low- |
|---|---|---|---|---|
| | | Load | Resistance | temperature |
| Experiment | D50 | retention | increase | retention |
| example | (μm) | rate (%) | rate (%) | rate (%) |
| 5-1 | 2 | 88 | 18 | 71 |
| 5-2 | 3.5 | 90 | 16 | 80 |
| 5-3 | 5 | 92 | 12 | 88 |
| 1-4 | 10 | 90 | 11 | 90 |
| 5-4 | 20 | 89 | 12 | 92 |
| 5-5 | 30 | 92 | 14 | 81 |
| 5-6 | 50 | 89 | 16 | 68 |

Positive electrode active material: LiNi_{0.5}Co_{0.2}Mn_{0.3}O₂,
Negative electrode active material: artificial graphite
Charge voltage Ec = 4.20 V,
Negative electrode potential Ef = 50 mV,
Negative electrode potential variation Ev = 17 mV

In a case where the median diameter D50 was within an appropriate range (from 3.5 μm to 30 μm both inclusive) (Experiment examples 1-4 and 5-2 to 5-5), the low-temperature retention rate increased while retaining a substantially equal load retention rate and a substantially equal resistance increase rate, as compared with a case where the median diameter D50 was outside the appropriate range (Experiment examples 5-1 and 5-6). In particular, in a case where the median diameter D50 was within a range of 5 μm to 20 μm both inclusive (Experiment examples 1-4, 5-3, and 5-4), the low-temperature retention rate further increased.

### Experiment Examples 6-1 to 6-5

As described in Table 6, secondary batteries were fabricated following which the battery characteristics of the secondary batteries were examined by similar procedures except that the configuration of the negative electrode 14 (the spacing S (nm) of the (002) plane of the negative electrode active material (the artificial graphite)) was changed.

TABLE 6

| | | | | Low- |
|---|---|---|---|---|
| | | Load | Resistance | temperature |
| Experiment | Spacing | retention | increase | retention |
| example | S (nm) | rate (%) | rate (%) | rate (%) |
| 6-1 | 0.3355 | 90 | 15 | 88 |
| 6-2 | 0.3356 | 88 | 11 | 95 |
| 1-4 | 0.3360 | 90 | 11 | 90 |
| 6-3 | 0.3363 | 89 | 10 | 96 |
| 6-4 | 0.3370 | 91 | 14 | 91 |
| 6-5 | 0.3375 | 91 | 14 | 87 |

Positive electrode active material: LiNi_{0.5}Co_{0.2}Mn_{0.3}O₂,
Negative electrode active material: artificial graphite
Charge voltage Ec = 4.20 V,
Negative electrode potential Ef = 50 mV,
Negative electrode potential variation Ev = 17 mV

In a case where the spacing S was within an appropriate range (from 0.3355 nm to 0.3370 nm both inclusive) (Experiment examples 1-4 and 6-1 to 6-4), the low-temperature retention rate increased while retaining a substantially equal load variation rate and a substantially equal resistance increase rate, as compared with a case where the spacing S was outside the appropriate range (Experiment example 6-5). In particular, in a case where the spacing S was within the range of 0.3356 nm to 0.3363 nm both inclusive (Experiment examples 1-4, 6-2, and 6-3), the low-temperature retention rate further increased.

### Experiment Examples 7-1 to 7-4

As described in Table 7, secondary batteries were fabricated following which the battery characteristics of the secondary batteries were examined by similar procedures except that the composition of the electrolytic solution was changed.

In a case of preparing the electrolytic solution, the halogenated carbonate ester (4-fluoro-1,3-dioxane-2-one (FEC)) was newly used as the solvent. A content (wt %) of FEC in the electrolytic solution was as described in Table 7.

TABLE 7

| | Halogenated | | | |
|---|---|---|---|---|
| | carbonate | | | |
| | ester | | Load | Resistance |
| Experiment | | Content | retention | increase |
| example | Kind | (wt %) | rate (%) | rate (%) |
| 1-4 | — | — | 90 | 11 |
| 7-1 | FEC | 0.1 | 92 | 11 |
| 7-2 | | 1 | 91 | 8 |
| 7-3 | | 5 | 91 | 5 |
| 7-4 | | 15 | 97 | 4 |

Positive electrode active material: LiNi_{0.5}Co_{0.2}Mn_{0.3}O₂,
Negative electrode active material: artificial graphite
Charge voltage Ec = 4.20 V,
Negative electrode potential Ef = 50 mV,
Negative electrode potential variation Ev = 17 mV

In a case where the electrolytic solution included the halogenated carbonate ester (Experiment examples 7-1 to 7-4), and where the content of the halogenated carbonate ester was from 1 wt % to 15 wt % both inclusive (Experiment examples 7-2 to 7-4), the resistance increase rate decreased while retaining a high load retention rate, as compared with a case where the content of the halogenated carbonate ester was less than 1 wt % (Experiment examples 1-4 and 7-1).

### Experiment Examples 8-1 to 8-7

As described in Table 8, secondary batteries were fabricated following which the battery characteristics of the secondary batteries were examined by similar procedures except that the kind of the negative electrode active material was changed.

In a case of fabricating the negative electrode 14, natural graphite, instead of artificial graphite, was used as the negative electrode active material. Further, in the case of fabricating the negative electrode 14, used as an additional negative electrode active material were a flame-retardant graphitized carbon (HC), a silicon-containing material (silicon oxide (SiO)), and another silicon-containing material (a composite material (Si/C) including a silicon-containing material (Si) and a carbon material (artificial graphite)). In this case, an addition amount of the additional negative electrode active material was set to 10 wt %.

TABLE 8
Positive electrode active material: LiNi_{0.5}Co_{0.2}Mn_{0.3}O₂

| | | | | | Negative | | |
|---|---|---|---|---|---|---|---|
| | Negative | | | Negative | electrode | | |
| | electrode | | Charge | electrode | potential | Load | Resistance |
| Experiment | active material | | voltage | potential | variation | retention | increase |
| example | Kind | Kind | Ec (V) | Ef (mV) | Ev (mV) | rate (%) | rate (%) |
| 1-4 | Artificial | — | 4.20 | 50 | 17 | 90 | 11 |
| | graphite | | | | | | |
| 8-1 | Natural | — | | | | 89 | 12 |
| | graphite | | | | | | |
| 8-2 | Artificial | HC | | | | 96 | 9 |
| 8-3 | graphite | SiO | | | | 97 | 9 |
| 8-4 | | Si/C | | | | 96 | 7 |
| 8-5 | Natural | — | 4.20 | 87 | <1 | 88 | 40 |
| 8-6 | graphite | | | 89 | <1 | 90 | 51 |
| 8-7 | | | | 92 | <1 | 89 | 59 |

As described in Table 8, similar results as those in Table 1 were obtained also in the case of changing the kind of the negative electrode active material. That is, in the case where the two configuration conditions (the negative electrode potential Ef and the negative electrode potential variation Ev) were satisfied (Experiment example 8-1), the resistance increase rate decreased while retaining a substantially equal high load retention rate, as compared with the case where the two configuration conditions were not satisfied together (Experiment Examples 8-5 to 8-7).

Further, in a case where the negative electrode 14 included the additional negative electrode active material (Experiment examples 8-2 to 8-4), the load retention rate further increased and the resistance increase rate further decreased, as compared with a case where the negative electrode 14 included no additional negative electrode active material (Experiment example 1-4).

Based upon the results described in Tables 1 to 8, in the case where the positive electrode 13 included the positive electrode active material (the layered rock-salt lithium-nickel composite oxide) and the negative electrode 14 included the negative electrode active material (graphite), and where the above-described two configuration conditions (the negative electrode potential Ef and the negative electrode potential variation Ev) were satisfied: the load characteristic and the electric resistance characteristic were each improved. Accordingly, superior battery characteristics of the secondary batteries were obtained.

Although the technology has been described above with reference to the embodiment and Examples, embodiments of the technology are not limited to those described with reference to the embodiment and Examples above and are modifiable in a variety of ways.

Specifically, although the description has been given of the laminated secondary battery, this is non-limiting. For example, the secondary battery may be of any other type such as a cylindrical type, a prismatic type, or a coin type. Moreover, although the description has been given of a case of the battery device having a wound structure to be used in the secondary battery, this is non-limiting. For example, the battery device may have any other structure such as a stacked structure.

It should be understood that the effects described herein are mere examples, and effects of the technology are therefore not limited to those described herein. Accordingly, the technology may achieve any other effect.

It should also be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a lithium-nickel composite oxide represented by Formula (1) and having a layered rock-salt crystal structure;
a negative electrode including graphite; and
an electrolytic solution, wherein
an open circuit potential, versus a lithium reference electrode, of the negative electrode measured in a full charge state is from 19 millivolts to 86 millivolts, the full charge state being a state in which the secondary battery is charged with a constant voltage of a closed circuit voltage of higher than or equal to 4.20 volts for 24 hours, and
a potential variation of the negative electrode represented by Formula (2) is greater than or equal to 1 millivolt when the secondary battery is discharged from the full charge state by a capacity corresponding to 1 percent of a maximum discharge capacity, the maximum discharge capacity being a discharge capacity obtained when the secondary battery is discharged with a constant current from the full charge state until the closed circuit voltage reaches 2.00 volts, following which the secondary battery is discharged with a constant voltage of the closed circuit voltage of 2.00 volts for 24 hours,
LiₓNi_{1-y}M_{y}O_{2-z}X_{z} (1)
wherein
M represents at least one of titanium (Ti), vanadium (V), chromium (Cr), cobalt (Co), manganese (Mn), iron (Fe), copper (Cu), sodium (Na), magnesium (Mg), aluminum (Al), silicon (Si), tin (Sn), potassium (K), calcium (Ca), zinc (Zn), gallium (Ga), strontium (Sr), yttrium (Y), zirconium (Zr), niobium (Nb), molybdenum (Mo), barium (Ba), lanthanum (La), tungsten (W), boron (B), and combinations thereof,
X represents at least one of fluorine (F), chlorine (Cl), bromine (Br), iodine (I), and sulfur (S), and
x, y, and z satisfy 0.8<x<1.2, 0≤y≤0.5, and 0≤z<0.05,
potential variation (millivolt(s)) of negative electrode=second negative electrode potential (millivolt(s))−first negative electrode potential (millivolt(s)) (2)
wherein
the first negative electrode potential is the open circuit potential, versus the lithium reference electrode, of the negative electrode measured in the full charge state, and
the second negative electrode potential is an open circuit potential, versus the lithium reference electrode, of the negative electrode measured in a state in which the secondary battery is discharged from the full charge state by the capacity corresponding to 1 percent of the maximum discharge capacity.

2. The secondary battery according to claim 1, wherein
the graphite includes a plurality of graphite particles, and
a median diameter D50 of the graphite particles is from 3.5 micrometers to 30 micrometers.

3. The secondary battery according to claim 1, wherein spacing of a (002) plane of the graphite is from 0.3355 nanometers to 0.3370 nanometers.

4. The secondary battery according to claim 1, wherein spacing of a (002) plane of the graphite is from 0.3355 nanometers to 0.3370 nanometers.

5. The secondary battery according to claim 1, wherein
the electrolytic solution includes a halogenated carbonate ester, and
a content of the halogenated carbonate ester in the electrolytic solution is from 1 weight percent to 15 weight percent.

6. The secondary battery according to claim 2, wherein
the electrolytic solution includes a halogenated carbonate ester, and
a content of the halogenated carbonate ester in the electrolytic solution is from 1 weight percent to 15 weight percent.

7. The secondary battery according to claim 3, wherein
the electrolytic solution includes a halogenated carbonate ester, and
a content of the halogenated carbonate ester in the electrolytic solution is from 1 weight percent to 15 weight percent.

8. The secondary battery according to claim 1, wherein the negative electrode further includes one or both of non-graphitizable carbon and a material including silicon.

9. The secondary battery according to claim 8, wherein the material including silicon includes a silicon oxide represented by Formula (3),
SiOᵥ (3)
wherein v satisfies 0.5≤v≤1.5.
